(19) United States
(12) Patent Application Publication
(10) Pub. No.: US 2006/0216538 A1
(43) Pub. Date: Sep. 28, 2006

(54) Method for treating wood product with reactive monomers and product resulting therefrom

(76) Inventors: Anthony Berejka, Huntington, NY (US); Mark Driscoll, Syracuse, NY (US); L. Scott Larsen, Watervliet, NY (US); Daniel E. Montoney, Seneca Falls, NY (US); Leonard Smith, Syracuse, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/414,693

(22) Filed: Apr. 28, 2006

Related U.S. Application Data
(63) Continuation of application No. PCT/US04/35781, filed on Oct. 28, 2004.
(60) Provisional application No. 60/515,019, filed on Oct. 28, 2003.

(51) Int. Cl. B05D 1/18; B05D 3/02; B27K 3/15

(52) U.S. Cl. 428/541; 427/440; 427/397

(57) ABSTRACT

The present invention provides methods of strengthening and/or protecting wood products with reactive monomers and other impregnable materials. For example, materials may be impregnated which protect the wood from environmental and insect decay and/or prevent the growth of fungi and molds. Other suitable materials include, for example, dyes to enhance the wood's grain, permitting the use of wood species with less attractive untreated appearances. A first aspect of the invention provides a method for treating a wood product comprising the steps of impregnating the wood product with at least one crosslinkable monomer, wherein the monomer is capable of penetrating a cell wall of the wood product and polymerizing the at least one crosslinkable monomer.

### CLAIM FOR PRIORITY

This is a continuation of International Application PCT/US2004/035781, with an International Filing Date of Oct. 28, 2004, currently pending, which claims priority to U.S. Provisional Patent Application 60/515019, filed on Oct. 28, 2003, both of which are hereby incorporated by reference herein.

### BACKGROUND OF THE INVENTION

(1) Technical Field

The present invention relates generally to methods for treating wood products and more specifically to methods for treating wood products with reactive monomers and the products resulting from such methods.

(2) Related Art

Many methods have been proposed for treating wood products with the aim of increasing the wood's strength and/or resistance to decay. Generally, such methods require the addition of a material to the open spaces (lumens) within the wood and/or to the surface of the wood. Plastics, resins, and other polymers can be used to add strength to wood. Biocides, fungicides, insecticides, and insect repellants can be used to resist decay. Often, such materials are forced into a wood product by subjecting it to a vacuum, which evacuates air from the voids within the wood, and then applying a force to the material, causing it to penetrate into the wood.

For example, UK Patent Application No. GB 2 383 052 A describes a method for treating wood that includes the infusion and polymerization of a hydrophilic monomer. The monomer is preferably infused as a vapor and polymerized by irradiation (UV, X-Ray, or gamma) or a combination of heat and a chemical initiator.

Similarly, U.S. Pat. No. 4,057,658 to Sjoo et al. describes a method for treating wood that includes the infusion of a polymerizable liquid monomer or oligomer in conjunction with a setting agent, wherein the setting agent is activated and the monomer or oligomer polymerized only at high temperatures or by electromagnetic radiation.

British Patent Specification No. 1 460 696 describes a method of treating wood comprising the steps of gamma irradiating the wood, impregnating the wood with a liquid or gaseous vinyl monomer, and polymerizing the impregnated monomer by a second gamma irradiation.

U.S. Pat. No. 5,395,656 to Liang describes a four-step process for treating wood that includes the removal of residual moisture from the wood, pressure injection of a composition containing polyethylene oxide (PEO) and polyvinyl pyrrolidone (PVP), removal of excess composition, and chemical activation of the composition to cause it to bond to both itself and the wood.

However, each of the references above, which are hereby incorporated by reference, involve the impregnation of a monomer or oligomer only into the wood's first order void space or gross capillary zone (cell lumens, pit apertures, etc.). While such voids often comprise between 30% and 75% of the volume of a piece of wood at 12% moisture content, untreated second order void space or transient capillary zone (cell wall capillaries or cell wall microvoids) leave the wood subject to decay (at moisture contents near or above its fiber saturation point) and dimensional instability as the liquid content of these spaces changes.

Accordingly, a need exists for a wood product having improved decay resistance and dimensional stability due to the presence of a crosslinked monomer within its second order void space as well as a method for the manufacture of such a wood product.

### SUMMARY OF THE INVENTION

The present invention provides methods of strengthening and/or protecting wood products with reactive monomers and other impregnable materials. For example, materials may be impregnated which protect the wood from environmental and insect decay and/or prevent the growth of fungi and molds. Other suitable materials include, for example, dyes to enhance the wood's grain, permitting the use of wood species with less attractive untreated appearances. A first aspect of the invention provides a method for treating a wood product comprising the steps of impregnating the wood product with at least one crosslinkable monomer, wherein the monomer is capable of penetrating a cell wall of the wood product and polymerizing the at least one crosslinkable monomer.

A second aspect of the invention provides a treated wood product, comprising at least one species of wood and at least one substantially polymerized monomer, wherein the monomer is located in both the first and second order void spaces of the wood.

The foregoing and other features of the invention will be apparent from the following more particular description of embodiments of the invention.

### DETAILED DESCRIPTION OF THE INVENTION

The methods of the present invention include the infusion of a crosslinkable monomer into a pre-conditioned wood product and the polymerization of at least a portion of the impregnated monomer. Additional steps, including, for example, impregnation of a preservative, may be desirable in some situations.

The monomers used in the present invention must not only be capable of entering the first order void spaces of the wood, but must also be capable of diffusing into wood cell walls, that is, entering the second order void spaces of the wood. The diffusion of a monomer into the cell wall capillaries greatly increases both the decay resistance and dimensional stability of the wood, following its polymerization. Crosslinkable monomers suitable for use in the methods and products of the present invention must be capable of diffusing into the cell wall of the wood species being treated. Preferred monomers include, but are not limited to, 2-hydroxyethyl methacrylate, ethoxylated 2-hydroxyethyl methacrylate, and polyethylene glycol (400) dimethacrylate.

The infusion of a monomer or monomers may be accomplished in any of a number of ways. For example, the wood may be submerged in the monomer(s) at room temperature and standard atmospheric pressure. Any of the preferred monomers above exhibit such an affinity for wood products that they will be drawn into both the first and second order void spaces. Alternatively, a vacuum source may be applied to the wood prior to immersion in one or more monomers, whereby the monomer(s) are drawn into both the lumens and cell wall capillaries. In addition, the monomer or monomers may be applied to the wood under pressure, forcing the monomer(s) into the first and second order void spaces.

Once impregnated, the monomer(s) may be polymerized using any of a number of methods known in the art, including, for example, application of a high voltage electron beam, application of radio-frequency waves, X-ray irradiation, and heating. Some polymerization methods, particularly the application of radio-frequency waves and heating, require the presence of an initiator or catalyst. Suitable initiators include peroxides. Surprisingly, it has been found that an optional preservative, copper sulfate, acts not only as a fungicide but as a catalyst for the polymerization of impregnated monomers.

The polymerization of impregnated monomers may be achieved by any means known in the art, including, for example, X-ray irradiation, heating, the application of radio-frequency waves, and bombardment by high voltage electron beam. Some methods, such as the application of radio-frequency waves and heating, require or are enhanced by the presence of a catalyst such as a peroxide or copper sulfate. Other methods are improved by the addition of a crosslink enhancer, such as trimethylolpropane triacrylate and ethoxylated trimethylolpropaned triacrylate esters. An illustrative polymerization means is X-ray irradiation, which does not require an initiator, may be applied at a lower dosage than electron beam polymerization, and results in little or no volatilization of the impregnated monomer.

Once polymerized, the monomer(s) impart any number of desirable characteristics to the wood. These include, for example, increased strength, improved dimensional stability, decreased water uptake, improved resistance to environmental (e.g., water, mildew, mold, and decay fungi etc.) or insect damage, improved visual appearance, and improved acoustic properties. Such improvements are described in greater detail below with respect to particular applications of wood products treated according to the present invention.

Additional steps, including the infusion of preservatives and/or dyes, may optionally be incorporated into the methods of the present invention. Such a step may be separate from the infusion of the monomer(s), utilizing any method known in the art, such as those described above. In some instances, it may be preferable that the infusion of a preservative or dye, if desired, is performed at the same time as the infusion of the monomer(s). This ensures more uniform infusion of both the monomer(s) and preservatives and/or dyes than if separate infusions were performed. In an illustrative embodiment, the liquid monomer or monomers are blended with any preservatives or dyes and the blend is then impregnated into the wood in a single infusion step. For example, where a borate is to be impregnated, it has been found that a monomer/borate blend comprising approximately 2.5% to 5.0% borate, by weight, is effective. Similarly, where the preservative is cupric nitrate, a blend comprising approximately 4.5% cupric nitrate, by weight, is also effective.

While the optional infusion of preservatives has been described above, it should be recognized that similar processes may be carried out for the infusion of dyes to enhance a visual appearance of the wood, particularly its grain. Any dye known in the art may be so employed.

The improved characteristics of wood products treated according to the methods of the present invention make them suitable for a wide range of applications. For example, engineered flooring comprising veneers treated according to the present invention exhibits increased hardness, dent resistance and dimensional stability, resulting in a more stable, longer lasting floor. In particular, the present invention overcomes one of the limitations of many current engineered wood floors, namely, the lack of protection from water (from traffic, washing, spills, etc.) on the surfaces and edges of the many pieces that constitute the floor. Untreated floors or those treated according to methods currently known in the art allow water to enter and cause the wood to swell. Such swelling results in insufficient float in the entire floor, leading to buckling.

With dimensional stability and water repellency of wood products treated with the methods of the present invention, the floor will resist water and have a lessened or no tendency to expand or contract. For example, conditioning of polymerized impregnated HEMA results in less than one percent average dimensional change from 75° F. and 78% relative humidity to 70° F. and 29% relative humidity. Untreated control samples, by comparison, exhibit a 4.73% average dimensional change in response to such a change in atmospheric conditions.

If only the top layer of the engineered wood floor is treated according to the present invention (for lower product cost), other measures, such as waxing, for example, would preferably be incorporated to prevent excessive moisture accumulation in the lower layers. Because wood treated according to the present invention does not tend to expand with exposure to water, there is no tendency for the wax to be squeezed out of the joints in the floor. For floors installed over fresh concrete, the concrete should be allowed to dry and a vapor retarder installed prior to installing the treated engineered wood floor. This is standard practice for installing wood floors over concrete.

The methods of the present invention may similarly be used in the manufacture of exterior siding, shingles, and other wood products subject to weather. When untreated, such products are prone to cupping, warping and splitting due to changes in moisture content. After treatment according to the present invention, such products are more dimensionally stable and can be treated with dyes to provide the desired color throughout the product. Additionally, preservatives and/or mildewcides can be incorporated into the treatment.

Furniture parts treated according to the present invention provide a dimensionally stable base for highly polished topcoats. Since the lumens are filled by polymerized monomers, sanding sealers and fillers are not necessary to prepare furniture parts for final finishing. A dimensionally stable base reduces or eliminates crazing and cracking of topcoats. Additionally, the incorporation of dyes into the wood will enable furniture makers to darken bands of sapwood, as well as stain under utilized species to mimic cherry or mahogany. Treatment according to the present invention adds, inter alia, heat resistance, stain resistance, and chemical resistance to furniture products such as table tops. Additional heat and/or chemical resistance can be achieved with suitable topcoat finishes. The methods of the present invention are equally applicable to the treatment of wood products for use in exterior furniture, where untreated wood is prone to mold and mildew growth, resulting in mottled black, brown, and green colors on wood surfaces. In addition, as the monomers and preservatives used in the methods of the present invention are generally safe and non-toxic, any leaching caused by exposure to rain, etc., will not pose a contact hazard to humans or animals.

Wood fibers and/or wood-flour may be treated according to the methods of the present invention. Such treatment results in a chemical link between hydrophobic resins and hydrophilic wood fibers. This makes possible the manufacture of wood thermoplastic composite decking that is stronger and more creep resistant than composite decking currently available.

Similarly, wood boards treated according to the present invention are suitable for use in exterior decking. The present methods avoid the undesirable green color seen in pressure treated decking. In addition, boards treated according to the present invention may not require the periodic maintenance associated with deck boards now available. The methods of the present invention may be used to manufacture wooden playground equipment that is safer for children to use than pressure-treated wood while also improving the wood's strength, dimensional stability, and resistance to decay.

The improved acoustic properties associated with polymer-impregnated woods have been previously described. See, e.g., British Patent Specification No. 1 460 696. The methods of the present invention, however, further provide greater dimensional stability and the ability to carry dyes into cell walls, imparting any desired color to the instrument's wood.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A method for treating a wood product comprising the steps of:
impregnating the wood product with at least one crosslinkable monomer, wherein the monomer is capable of penetrating a cell wall of the wood product; and
polymerizing the at least one crosslinkable monomer.

2. The method of claim 1, wherein the impregnating step includes the submersion of the wood product in at least one liquid crosslinkable monomer and evacuation of air from the wood product.

3. The method of claim 1, wherein the impregnating step includes at least one of vacuum impregnation and pressure impregnation of the at least one crosslinkable monomer.

4. The method of claim 1, wherein the crosslinkable monomer is selected from a group consisting of 2-hydroxyethyl methacrylate, ethoxylated 2-hydroxyethyl methacrylate, and polyethylene glycol (400) dimethacrylate.

5. The method of claim 1, wherein the impregnating step further includes the impregnation of at least one of a dye and a preservative.

6. The method of claim 5, wherein the preservative is at least one of a fungicide, a biocide, an insecticide, and an insect repellant.

7. The method of claim 5, wherein the preservative is at least one of a borate, copper sulfate, and cupric nitrate.

8. The method of claim 1, wherein the polymerizing step includes applying to the wood product at least one of a high voltage electron beam, an external heat source, radio waves, and X-rays.

9. The method of claim 8, wherein the polymerizing step further includes the use of at least one of a polymerization catalyst and a crosslink enhancer.

10. The method of claim 9, wherein the catalyst is at least one of a peroxide and copper sulfate.

11. The method of claim 9, wherein the crosslink enhancer is at least one of trimethylolpropane triacrylate and ethoxylated trimethylolpropaned triacrylate esters.

12. The method of claim 10, wherein copper sulfate acts as both a polymerization catalyst and a fungicide.

13. The method of claim 1, wherein at least one of a strength, a dimensional stability, a resistance to decay, a resistance to water uptake, a visual appearance, and an acoustic property of the wood product is improved.

14. A treated wood product, comprising:
at least one species of wood; and
at least one substantially polymerized monomer, wherein the monomer is located in both first and second order void spaces of the wood.

15. The product of claim 14, wherein the monomer is selected from a group consisting of 2-hydroxyethyl methacrylate, ethoxylated 2-hydroxyethyl methacrylate, and polyethylene glycol (400) dimethacrylate.

16. The product of claim 14, further comprising a dye for enhancing a visual appearance of the product.

17. The product of claim 14, further comprising a preservative for protecting the product.

18. The product of claim 17, wherein the preservative is at least one of a fungicide, a biocide, an insecticide, and an insect repellant.

19. The product of claim 17, wherein the preservative is at least one of a borate, copper sulfate, and cupric nitrate.

20. The product of claim 14, wherein the at least one species of wood is in the form of at least one of wood fibers and wood-flour.

21. The product of claim 14, having at least one of an increased strength, an improved dimensional stability, an increased resistance to decay, an increased resistance to water uptake, an enhanced visual appearance, and an enhanced acoustic property.
